(19) United States
(12) Patent Application Publication
(10) Pub. No.: US 2008/0128354 A1
(43) Pub. Date: Jun. 5, 2008

(54) METHOD FOR WASHING FILTRATION MEMBRANES

(75) Inventors: John Lombardi, Boulder, CO (US); Larry Lien, Solana Beach, CA (US)

Correspondence Address: SHERIDAN ROSS PC, 1560 BROADWAY, SUITE 1200, DENVER, CO, 80202, US

(73) Assignee: HW ADVANCED TECHNOLOGIES, INC., Lakewood, CO (US)

(21) Appl. No.: 11/946,533

(22) Filed: Nov. 28, 2007

Related U.S. Application Data
(60) Provisional application No. 60/867,940, filed on Nov. 30, 2006.
(60) Provisional application No. 60/950,186, filed on Jul. 17, 2007.

(51) Int. Cl. B01D 65/06; B01D 61/00

(52) U.S. Cl. 210/636

(57) ABSTRACT

A membrane filter washing method is provided using a wash solution containing a determined concentration of a leaching agent.

### CROSS REFERENCE TO RELATED APPLICATION

The present application claims the benefits of U.S. Provisional Application Ser. No. 60/867,940, filed Nov. 30, 2006, entitled “Method for Washing Filtration Membranes”, which is incorporated herein by this reference.

### FIELD OF THE INVENTION

The invention relates generally to membrane filtration and particularly to washing filtration membranes to remove selected foulants.

### BACKGROUND OF THE INVENTION

With water shortages and environmental protection gaining global importance, membrane treatment of contaminated waters is becoming more widespread. Membranes can separate effectively suspended solids, entrained oils and greases, dissolved solids, and dissolved organics, and produce a low contaminant-content permeate water. Membranes can also conserve reagent-loaded matrix waters for recycle and recover valuable metals from metal-loaded waters.

As shown in FIG. 1, a membrane system 100 pushes feed water across leaves of membrane material 104 with a permeate pocket on the underside of the leaf. The leaves are spiral wound around a hollow central porous tube 108. The permeate pockets communicate with the interior 112 of the central tube 108. Typical commercial membrane packages, called membrane elements, are 2½″, 4″ or 8″ diameter and 39″ long. The elements are connected in series element-by-element by permeate tube inter-connectors in, typically, six element lengths. The connected elements are confined in a pipe 116 with end-caps called a membrane vessel or unit. A unit may contain one or more membrane elements. Feed water 124 is pumped into the vessel at one end and exits out the other, less the volume of permeate that was collected to the central tube for recovery. The liquid on the rejection side 120 of the membrane is called the concentrate or retentate, and the fluid that passes through the membrane into the central tube 108 is called the permeate.

Membranes can have a high “fouling” potential when used to treat waters carrying organics, dissolved solids (such as salts (e.g., sulfates, carbonates, and phosphates), hydroxides, polymers, guar, and colloids), metals and metal complexes (e.g., copper, zinc, mercury, cadmium, cobalt, tin, gold, and silver and complexes thereof), and other contaminants. The concentration(s) of the contaminant(s) in such waters typically range(s) from about 500 to about 130,000 ppm.

As shown in FIG. 2, these contaminants can, upon concentration, exceed solubility limits and precipitate and/or form deposits 200 that occlude areas of the rejection side 120 of the membrane surface, decrease the active surface area of the surface, and inhibit efficient permeate production. As permeate water is extracted from a feed water, the concentrate water adjacent to the rejection side 120 of the membrane becomes increasingly contaminated with the dissolved contaminants. By extracting permeate water, the contaminant content of the concentrate water becomes layered atop the rejection side 120 of the membrane such that the degree of contaminant content is greatest at the membrane surface in what is called the “boundary layer,” 128, i.e., the contaminants tend to “stack-up” at the membrane rejection interface. The boundary layer 128 is a zone where there is a high potential for the formation and precipitation of contaminants and amalgams due to the presence of dissolved contaminants in excess of their solubility limits. The resulting precipitate solids can adhere to and occlude the membrane surface. Membrane occlusion by such deposits 200 reduces the rate of passage of permeate water at a given pressure and is referred to as “membrane fouling.” To reduce the potential for membrane fouling, state-of-the-art industrial membrane water treatment plants are designed as flow-through units, i.e., as units where a cross-flow of pressurized concentrate water passes over the membrane at all times to purposely sweep the membrane surface and disrupt the formation of the boundary layer.

Notwithstanding the flow-through design, membrane units often require careful washing regimens to remove deposits 200, and thereby restore desired levels of fluid flow. In many such cases, however, the use of water as a wash agent is insufficient to cleanse the membrane surface.

There is thus a need for an effective means of removing unwanted deposits from the membrane surface.

### SUMMARY OF THE INVENTION

These and other needs are addressed by the various embodiments and configurations of the present invention. The present invention is directed to membrane wash solutions comprising one or more leaching agents to remove deposits from membrane surfaces.

In a first embodiment, a method includes the steps of:

(a) receiving a valuable metal-containing solution, the metal-containing solution including a leaching agent, a dissolved valuable metal, and a dissolved contaminant;

(b) passing the valuable metal-containing solution through a number of membrane units to form a permeate comprising most of the valuable metal and a retentate comprising most of the dissolved contaminant;

(c) determining that a wash of a selected membrane is required;

(d) in response, ceasing to pass the valuable metal-containing solution through the selected membrane;

(e) in response, passing a wash solution through the selected membrane, the wash solution including the leaching agent and less dissolved valuable metal than the valuable metal-containing solution, and one or more of the following:
(E1) a second concentration of the dissolved contaminant in the wash solution that is lower than the first contaminant concentration in the valuable metal-containing solution; and
(E2) a second concentration of the leaching agent in the wash solution that is higher than the first leaching agent concentration in the valuable metal-containing solution;

(f) when the wash is determined to be completed, ceasing to pass the wash solution through the selected membrane; and

(g) thereafter again passing valuable metal-containing solution through the selected membrane.

The present invention can provide a number of advantages depending on the particular configuration. For example, unwanted deposits on the membrane surface can be removed rapidly and effectively by the wash solution without a significant degradation in membrane performance or operating life. The use of a wash solution having a reduced contaminant and/or elevated leaching agent concentration(s) can shift the dissolved solids equilibria in favor of dissolved, rather than precipitated, solids. The leaching agent can thus dissolve readily metal precipitates and metal amalgams. Cyanide-containing wash solutions, in particular, can not only remove metal precipitates and amalgams but also act as a biocide to destroy colonies of biota that often form in membrane plants, particularly those processing pond waters. In fact, bio-fouling can be the primary reason for washing the membrane with strong cyanide.

These and other advantages will be apparent from the disclosure of the invention(s) contained herein.

As used herein, “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

It is to be noted that the term “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

A “solution derived therefrom” refers to a solution having at least one common component with the source solution from which the solution is derived. For example, a solution having a leaching agent, contaminant, or valuable metal found in the source solution is deemed to be derived therefrom. Thus, a retentate and permeate are deemed to be solutions derived from the feed solution. Likewise, a loaded eluate, which contains the valuable metal, is deemed to be derived from the metal-containing pregnant leach solution, and a raffinate, which contains the leaching agent in the pregnant leach solution, is deemed to be derived from the pregnant leach solution.

The preceding is a simplified summary of the invention to provide an understanding of some aspects of the invention. This summary is neither an extensive nor exhaustive overview of the invention and its various embodiments. It is intended neither to identify key or critical elements of the invention nor to delineate the scope of the invention but to present selected concepts of the invention in a simplified form as an introduction to the more detailed description presented below. As will be appreciated, other embodiments of the invention are possible utilizing, alone or in combination, one or more of the features set forth above or described in detail below.

### BRIEF DESCRIPTION OF THE DRAWINGS

FIG. 1 is an end cross-section of a membrane unit according to the prior art;

FIG. 2 is a side cross-section of a membrane unit according to the prior art;

FIG. 3 is a flow chart according to an embodiment of the present invention;

FIG. 4 is a flow chart according to an embodiment of the present invention.

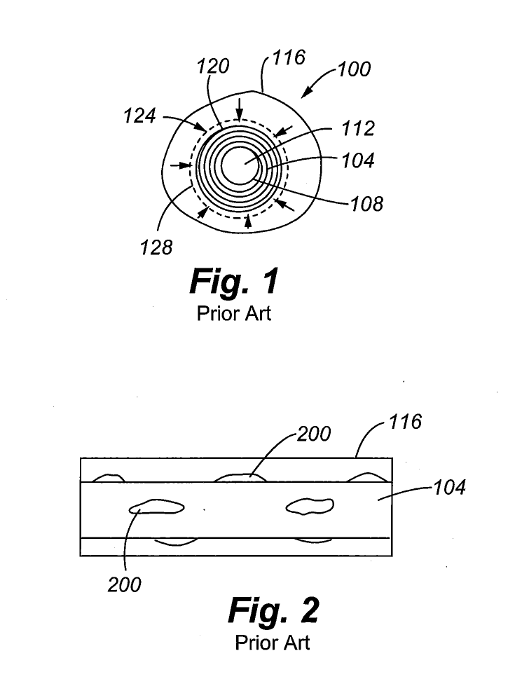

### DETAILED DESCRIPTION

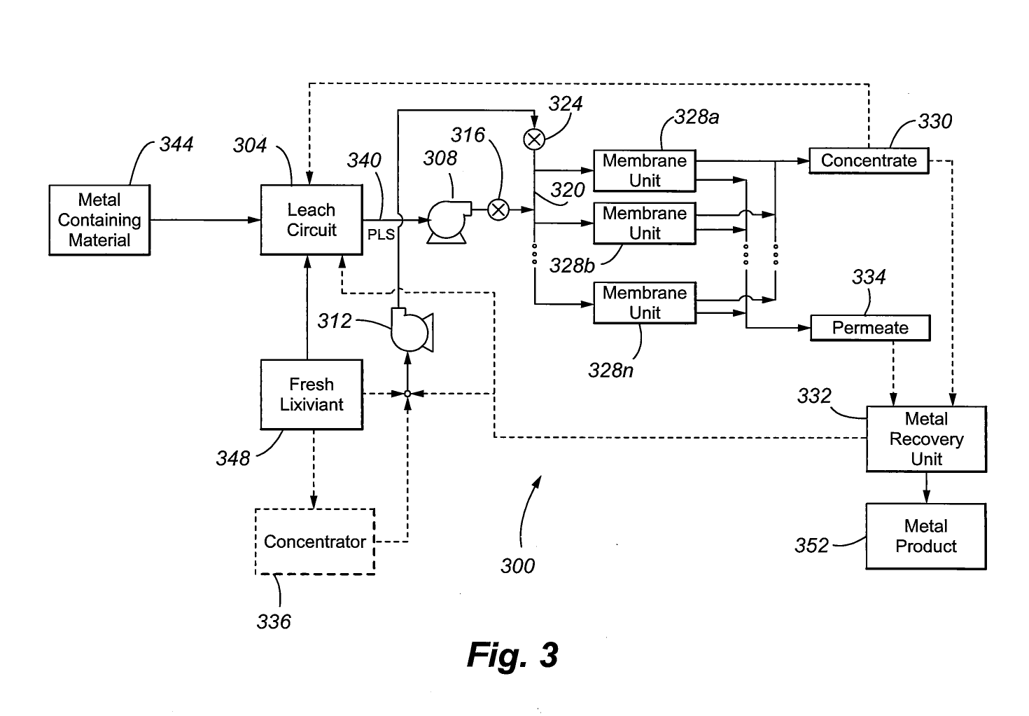

FIG. 3 shows an embodiment according to a first embodiment of the invention.

The system 300 includes a leach circuit 304, feed pump 308, wash pump 312, shut off valve 316, manifold 320, wash valve 324, a plurality of membrane units 328a-n to produce a concentrate or retentate 330 containing most of a selected material, such as a contaminant, in the pregnant leach solution 340 and a permeate 334 containing most of the target or valuable metal in the metal-containing material 344, a metal recovery circuit 332, and an optional concentrator 336.

The metal-containing material 344 typically includes the valuable or target metals in the form of oxides and/or sulfides. The metals can be any suitable metal, including precious metals, platinum group metals, and base metals. The material 344 can be an ore, concentrate, tailings, mine dump material, or any other type of metal-containing material.

The leach circuit 304 can be of any suitable leaching configuration, whether performed at superatmospheric or atmospheric pressure, ambient or elevated temperature, or requiring chemical, thermal, or bio-oxidation. Leaching can be performed in a stirred or agitated vessel (such as a vat or autoclave) or in a dump or on a leach pad. The leach circuit 304 receives a metal-containing material 344 and, using a lixiviant or leaching solution, solubilizes, or dissolves, most of the metals in the material 344, typically as soluble metal salts, to form the pregnant leach solution 340. The lixiviant applied to the material can be alkaline or acidic or a combination thereof. The latter combination would occur when leaching is performed in multiple stages, with the first stage using an alkaline or acidic lixiviant and the second stage using the other type of lixiviant.

The lixiviant is commonly an aqueous solution comprising a leaching agent that directly or indirectly dissolves the target metal in the material 344. Exemplary acidic leaching agents include mineral acids, such as sulfuric acid, hydrochloric acid, nitric acid, hydrofluoric and citric acid. Exemplary alkaline leaching agents include thiosulfate, thiourea, cyanide, caustic, thiocyanide and alkali solutions.

The membrane units 328a-n can be any suitable semi-permeable membrane. Exemplary membranes include hyperfilters (having a typical pore size ranging from about 0.0001 to about 0.001 microns), nanofilters (having a typical pore size ranging from about 0.001 to about 0.01 microns), leaky reverse osmosis membranes (having a typical pore size of around 0.001 microns), and ultrafilters (having a typical pore size ranging from about 0.005 to about 0.1 microns).

The membrane units 328a-n can isolate the target metal in the concentrate 330 or permeate 334. For example, when the target metal is present in solution as a monovalent ion the metal will pass readily through leaky RO membranes, nanofilters, and ultrafilters and will therefore be in both the concentrate and permeate. When the target metal is present in solution as a divalent ion, it may or may not pass readily through such membranes. When the target metal is present in solution as a trivalent or higher ion, it will be concentrated in the concentrate 330.

The leaching agent in the lixiviant may or may not pass through the membrane unit 328a-n into the permeate 334. Monovalent leaching agents, such as cyanide, or leaching agents having a small molecular or atomic size, such as sulfuric acid, are generally passed by ultrafilters, leaky RO membranes, and nanofilters but not by hyperfilters.

Generally, monovalent contaminants or contaminants having a small molecular or atomic size are passed by the membrane units 328a-n while multivalent or larger sized contaminant ions or molecules may be passed or retained by the membrane units 328a-n, depending on the particular membrane unit selected. Depending on the type of membrane unit employed, exemplary undesired contaminants that are preferentially retained by the membrane units 328a-n and form undesirable deposits 200, include multi-valent ions, contaminates having a large molecular or atomic size, sulfates, carbonates, silicates, and phosphates. Most of the undesired contaminants in the pregnant leach solution 340 are commonly concentrated in the retentate 330.

To remove deposits from the rejection side 120 of the membrane units 328a-n, a wash solution is passed through the membrane unit 328a-n during a wash cycle. The wash solution has a lower contaminant concentration and/or higher leaching agent concentration than the pregnant leach solution 340 so that the material deposited on the membrane surface 120 is not in equilibrium, thereby causing the material to be redissolved into the wash solution. In this manner, the membrane unit 328a-n is defouled by removal of most, if not all, of the material deposited on the membrane surface 120.

In one configuration, the wash solution has a higher leaching agent concentration (hereinafter second leaching agent concentration) than the concentration of the pregnant leach solution 340 or recycled (barren) lixiviant or raffinate (first leaching agent concentration) applied to the material 344 during leaching. In this configuration, the second leaching agent concentration is preferably at least about 200% and more preferably ranges from about 200% to about 1000% of the first leaching agent concentration. The target or valuable metal concentration (hereinafter second target metal concentration) is preferably less than that of the pregnant leach solution 340 (first target metal concentration). Preferably, the second target metal concentration is no more than about 1% and more preferably no more than about 0.1% of the first target metal concentration. Commonly, the first leaching agent concentration will range from about 0.1% to about 0.05% and the second leaching agent concentration from about 1% to about 5%, and the first target metal concentration from about 0.01% to about 0.05% and the second target metal concentration is no more than about 0.001%. This configuration is useful where the membrane units 328a-n either preferentially reject or preferentially pass the leaching agent.

In another configuration, the wash solution has a lower contaminant concentration (second contaminant concentration) than that of the pregnant leach solution 340 (first contaminant concentration). Preferably, the second contaminant concentration is no more than about 1% and more preferably no more than about 0.1% of the first contaminant concentration. Commonly, the first contaminant concentration ranges from about 0.1% to about 0.5%, and the second contaminant concentration is no more than about 0.01%. The second leaching agent concentration may or may not be greater than the first leaching agent concentration. This configuration is useful where the membrane units 328a-n preferentially reject the leaching agent.

In either configuration, the wash solution can be made up of the fresh lixiviant (which is substantially free of the target or valuable metal), the barren lixiviant (after target metal removal), a raffinate solution (when solvent extraction is used to effect metal recovery), the concentrate 330 (when the membrane unit 328a-n preferentially rejects substantially the leaching agent and most of the contaminant has been removed from the concentrate before reuse), and/or the permeate 334 (when the membrane unit 328a-n preferentially passes substantially the leaching agent).

In either configuration, the wash solution, before use, may be passed through concentrator 336 to increase the concentration of the leaching agent, commonly by removal of water. The concentrator 336 can be, for example, an evaporator or other type of heated container causing removal of water vapor, a retention vessel that loses water vapor through the combined effects of ambient humidity and sunlight, a membrane unit (such as a hyperfilter) that preferentially rejects the leaching agent but passes water, and the like. Alternatively, the second leaching agent concentration can be realized through mixing the fresh lixiviant with a more or less leaching agent-concentrated solution.

The system 300 can have many modes of operation.

In a first mode of operation, the target metal, particularly gold or silver, is present in the pregnant leach solution 340 as a monovalent ion, the leaching agent is one or more of cyanide, thiosulfate, thiocyanide, and thiourea, and the lixiviant has an alkaline or acid pH. The contaminant is one or more of a multivalent metal ion, particularly the cupric ion, mercuric ion, zinc ion, cadmium ion, tin ion, sulfates, carbonates, phosphate, and fluoride. The pregnant leach solution 340 is passed through the membrane units 328a-n to produce a concentrate 330 comprising most of the contaminant(s) and some of the target metal and a permeate 334 containing most of the target metal (due to the significantly greater volume of the permeate compared to the concentrate 330). Depending on whether the type of membrane unit rejects or passes the leaching agent, most of the leaching agent is in the concentrate 330 or permeate 334, respectively. In this mode, the concentrate 330 is recycled to the leach circuit 304, where it is combined with fresh lixiviant 348 and reapplied to the metal-containing material 344. The permeate 334 is subjected to metal recovery 332 to form a metal product 348 of high purity. Suitable recovery techniques include precipitation of the target metal (as a sulfide), cementation, solvent or resin extraction or carbon extraction followed by elution and electrowinning, and the like. The leaching agent in the permeate 334 isolated during metal recovery 332 can be recycled to the leach circuit 304 and/or used as part of the wash solution.

In a second mode, the target metal, particularly copper, nickel, cobalt, or zinc, is present in the pregnant leach solution 340 as a multivalent ion, the leaching agent is a mineral acid, and the lixiviant has an acidic pH. The contaminant is typically one or more of a trivalent ion, particularly iron (III), chromium (III), and/or higher valency ion, particularly aluminum V. The pregnant leach solution 340 is passed through the membrane units 328a-n to produce a concentrate 330 comprising most of the contaminant(s) and some of the target metal and a permeate 334 containing most of the target metal (due again to the significantly greater volume of the permeate compared to the concentrate 330). Depending on whether the type of membrane unit preferentially rejects or passes the leaching agent, most of the leaching agent is in the concentrate 330 or permeate 334, respectively. In this mode, the concentrate 330 is recycled to the leach circuit 304, where it is combined with fresh lixiviant 348 and reapplied to the metal-containing material 344. The permeate 334 is subjected to metal recovery 332 to form a metal product 348 of high purity. Suitable recovery techniques include those noted above. The leaching agent in the permeate 334 isolated during metal recovery 332 can be recycled to the leach circuit 304 and/or used as part of the wash solution.

In another mode, the target metal is divalent (e.g., copper), the lixiviant alkaline (e.g., cyanide), and the contaminant has a valency of three or higher (e.g., iron III).

In yet another mode, the target metal is monovalent (e.g., gold), the lixiviant acidic (e.g., thiourea in a mineral acid), and the contaminant has a valency of two or higher (e.g., copper, zinc, or nickel).

In another embodiment, an alkaline wash reagent, particularly cyanide, is used as a membrane wash reagent to dissolve membrane-fouling, precipitated metals and concurrently destroy membrane-fouling colonies of bio-organisms. This embodiment is particularly useful to treat the water from oil and gas wells. These waters, generally originating deep within the earth, are equilibrated to the ambient subterranean conditions and may contain, for example, high concentrations of dissolved salts and carbonates. When these waters are brought to surface conditions and further concentrated, as on the retaining side 120 of a membrane unit, the excess dissolved solids will precipitate out of solution and form deposits 200 on the membrane surface. The alkaline wash reagent preferably has a cyanide concentration ranging from about 1 to about 10 wt. % of dissolved leaching agent (e.g., sodium cyanide or its equivalent). The wash reagent, concurrent with the dissolution of metals from the surface of a membrane, acts as a biocide and destroys colonies of biota that often form in membrane plants, particularly when pond waters are processed.

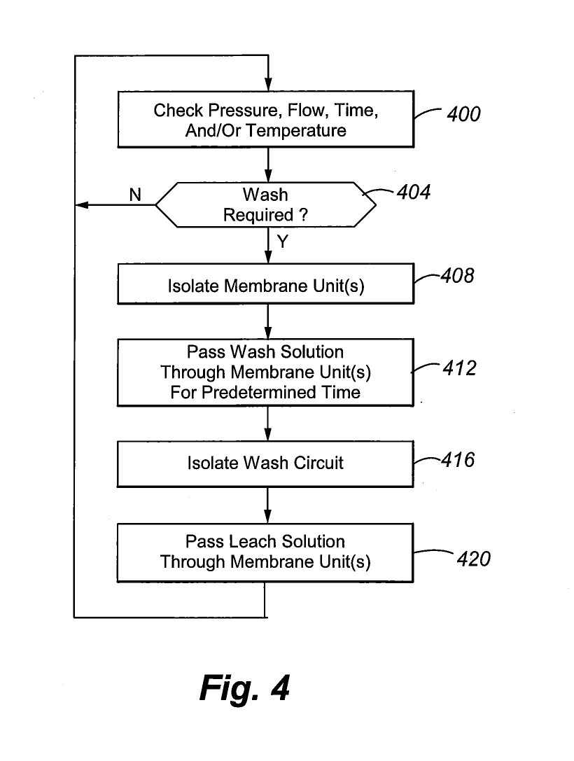

The process to clean deposits from the retaining sides 120 of the membrane units will now be described with reference to FIG. 4.

In step 400, a processor first checks liquid pressure upstream or downstream of the membrane units 328a-n, flow rate of the permeate and/or concentrate, time, and/or temperature readings to determine whether or not a wash is required. As will be appreciated, the readings are compared against corresponding setpoints.

In decision diamond 404, if a wash is not required step 400 is repeated after a set period of time. If a wash is required, control passes to step 408.

In step 408, the membrane units 328a-n are isolated. In other words, the feed pump 308 is deactivated and the shut down valve 316 is closed.

In step 412, the wash solution is passed through the membrane units 328a-n for a predetermined time as controlled either manually or automatically. This is done by opening the wash valve 324 and activating the wash pump 312. The wash solution concentrate is sent to a waste-solution containment for disposal or re-generation. The wash solution permeate, depending on the leaching agent concentration, may be recycled to the leach or wash circuit.

In step 416, after the predetermined time has elapsed the wash circuit is isolated by deactivating the wash pump 312 and closing the wash valve 324.

In step 420, the pregnant leach solution 340 is again passed through the membrane units 328a-n. This is done by opening the shut off valve 316 and activating the feed pump 308.

Control then returns to step 400.

### EXPERIMENTAL

A number of variations and modifications of the invention can be used. It would be possible to provide for some features of the invention without providing others.

In one embodiment of the method of the present invention a “cyanide barren” membrane treatment was effected where the free cyanide content of the barren was approximately 100 ppm as sodium cyanide. It was determined that the tail-end membrane elements in the barren water treatment process were being occluded by some kind of precipitate that was not dissolvable by using either conventional high pH (Caustic based) or conventional low pH (sulfuric acid based) membrane system was reagents. Further evaluation of the occluding substance indicated it to be a zinc-mercury amalgam. By the process of the present invention a 700 ppm sodium cyanide solution with only “traces” of mercury and zinc (trace is stipulated to be dissolved metal contents in the less than 30 parts-per-billion range) was circulated through the membrane plant and the occluding precipitate was observed to be entirely dissolved and removed from the surfaces of the affected membrane elements as was determined by the observed restoration of plant permeate rate production performance that was 100% of the plant pre-fouled down permeate rate production performance.

The present invention, in various embodiments, includes components, methods, processes, systems and/or apparatus substantially as depicted and described herein, including various embodiments, subcombinations, and subsets thereof. Those of skill in the art will understand how to make and use the present invention after understanding the present disclosure. The present invention, in various embodiments, includes providing devices and processes in the absence of items not depicted and/or described herein or in various embodiments hereof, including in the absence of such items as may have been used in previous devices or processes, e.g., for improving performance, achieving ease and\or reducing cost of implementation.

The foregoing discussion of the invention has been presented for purposes of illustration and description. The foregoing is not intended to limit the invention to the form or forms disclosed herein. In the foregoing Detailed Description for example, various features of the invention are grouped together in one or more embodiments for the purpose of streamlining the disclosure. The features of the embodiments of the invention may be combined in alternate embodiments other than those discussed above. This method of disclosure is not to be interpreted as reflecting an intention that the claimed invention requires more features than are expressly recited in each claim. Rather, as the following claims reflect, inventive aspects lie in less than all features of a single foregoing disclosed embodiment. Thus, the following claims are hereby incorporated into this Detailed Description, with each claim standing on its own as a separate preferred embodiment of the invention.

Moreover, though the description of the invention has included description of one or more embodiments and certain variations and modifications, other variations, combinations, and modifications are within the scope of the invention, e.g., as may be within the skill and knowledge of those in the art, after understanding the present disclosure. It is intended to obtain rights which include alternative embodiments to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. A method, comprising:
(a) contacting a leaching agent with a valuable metal-containing material to form a pregnant leach solution comprising at least a portion of the valuable metal in the valuable metal-containing material;
(b) in a first operating mode, passing a portion of the pregnant leach solution and/or a valuable metal-containing solution derived therefrom through a membrane unit to form a retentate and permeate comprising at least most of the valuable metal in the portion of the pregnant leach solution and/or valuable metal-containing solution derived therefrom, wherein the pregnant leach solution and/or valuable metal-containing solution derived therefrom comprises a dissolved contaminant having a first contaminant concentration, wherein the pregnant leach solution and/or valuable metal-containing solution derived therefrom has a first leaching agent concentration of the leaching agent, and wherein the retentate comprises at least most of the dissolved contaminant in the pregnant leach solution and/or valuable metal-containing solution derived therefrom; and
(c) in a second operating mode, passing a wash solution comprising the leaching agent through the membrane unit, wherein the first and second operating modes are performed at different times, wherein the wash solution comprises less dissolved valuable metal than the pregnant leach solution and/or valuable metal-containing solution derived therefrom, and wherein at least one of the following is true:
(C1) a second concentration of the dissolved contaminant in the wash solution is lower than the first contaminant concentration; and
(C2) a second concentration of the leaching agent in the wash solution is higher than the first leaching agent concentration.

2. The method of claim 1, wherein (C1) is true.

3. The method of claim 2, wherein the second leaching agent concentration is at least about 1% of the first leaching agent concentration.

4. The method of claim 2, wherein the second contaminant concentration is no more than about 5% of the first contaminant concentration.

5. The method of claim 2, wherein a second valuable metal concentration of the dissolved valuable metal in the wash solution is no more than about 1% of a first valuable metal concentration of the dissolved valuable metal in the pregnant leach solution and/or valuable metal-containing solution derived therefrom.

6. The method of claim 1, wherein (C2) is true.

7. The method of claim 2, wherein the second leaching agent concentration is at least about 200% of the first leaching agent concentration.

8. The method of claim 2, wherein the second contaminant concentration is no more than about 1000% of the first contaminant concentration.

9. The method of claim 2, wherein a second valuable metal concentration of the dissolved valuable metal in the wash solution is no more than about 1% of a first valuable metal concentration of the dissolved valuable metal in the pregnant leach solution and/or valuable metal-containing solution derived therefrom.

10. The method of claim 1, wherein the membrane unit is at least one of an ultrafilter, a leaky reverse osmosis membrane, a hyperfilter, and a nanofilter, wherein the dissolved contaminant is at least one of a divalent metal other than the valuable metal, a trivalent metal other than the valuable metal, a sulfate, a carbonate, a phosphate, a fluoride, and mixtures thereof, wherein the second leaching agent concentration is at least about 0.1%, and wherein the second contaminant concentration is no more than about 0.01%.

11. In a membrane separation system, the membrane system comprising a plurality of membrane units, a method comprising:
(a) receiving a valuable metal-containing solution, the metal-containing solution comprising a leaching agent, a dissolved valuable metal, and a dissolved contaminant;
(b) passing the valuable metal-containing solution through the plurality of membrane units to form a permeate and a retentate;
(c) determining that a wash of at least one of the membranes is required;
(d) in response, ceasing to pass the valuable metal-containing solution through the at least one of the membranes;
(e) in response, passing a wash solution through the at least one of the membranes, wherein the wash solution comprises the leaching agent, wherein the wash solution comprises less dissolved valuable metal than the valuable metal-containing solution, and wherein at least one of the following is true of the wash solution:
(E1) a second concentration of the dissolved contaminant in the wash solution is lower than the first contaminant concentration; and
(E2) a second concentration of the leaching agent in the wash solution is higher than the first leaching agent concentration;
(f) when the wash is determined to be completed, ceasing to pass the wash solution through the at least one of the membranes; and
(g) thereafter again passing valuable metal-containing solution through the at least one membrane.

12. The method of claim 11, wherein (E1) is true.

13. The method of claim 12, wherein the second leaching agent concentration is at least about 200% of the first leaching agent concentration.

14. The method of claim 12, wherein the second contaminant concentration is no more than about 1% of the first contaminant concentration.

15. The method of claim 12, wherein a second valuable metal concentration of the dissolved valuable metal in the wash solution is no more than about 0.1% of a first valuable metal concentration of the dissolved valuable metal in the valuable metal solution.

16. The method of claim 11, wherein (E2) is true.

17. The method of claim 12, wherein the second leaching agent concentration is at least about 200% of the first leaching agent concentration.

18. The method of claim 12, wherein the second contaminant concentration is no more than about 1% of the first contaminant concentration.

19. The method of claim 12, wherein a second valuable metal concentration of the dissolved valuable metal in the wash solution is no more than about 0.1% of a first valuable metal concentration of the dissolved valuable metal in the valuable metal solution.

20. The method of claim 11, wherein the permeate comprises at least most of the valuable metal and the retentate at least most of the dissolved contaminant in the valuable metal-containing solution, wherein the membrane unit is at least one of an ultrafilter, a leaky reverse osmosis membrane, a hyperfilter, and a nanofilter, wherein the dissolved contaminant is at least one of a divalent metal other than the valuable metal, a trivalent metal other than the valuable metal, a sulfate, a carbonate, a phosphate, a fluoride, and mixtures thereof, wherein the second leaching agent concentration is at least about 200%, and wherein the second contaminant concentration is no more than about 1%.

21. A method, comprising:
(a) receiving a feed solution, the feed solution comprising a dissolved contaminant;
(b) passing the feed solution through the plurality of membrane units to form a permeate and a retentate comprising at least most of the dissolved contaminant;
(c) determining that a wash of at least one of the membranes is required;
(d) in response, ceasing to pass the feed solution through the at least one of the membranes;
(e) in response, passing a wash solution through the at least one of the membranes, wherein the wash solution comprises cyanide to remove unwanted deposits from the at least one of the membranes;
(f) when the wash is determined to be completed, ceasing to pass the wash solution through the at least one of the membranes; and
(g) thereafter again passing the feed solution through the at least one membrane.

22. The method of claim 21, wherein the wash solution comprises from about 1 to about 10 wt. % cyanide.
